(19) United States
(12) Patent Application Publication
(10) Pub. No.: US 2002/0185176 A1
(43) Pub. Date: Dec. 12, 2002

(54) Pressure vessel for a pulp mill having overflow chute

(76) Inventors: Aaron T. Leavitt, Alpharetta, GA (US); David J. Lebel, Queensbury, NY (US); Patrick J. Pepin, Queensbury, NY (US); Helena C. Aguiar, Alpharetta, GA (US); C. Bertil Stromberg, Bolton Landing, NY (US); Michael Rutter, Suwanee, GA (US); Patrick J. Sullivan, Argyle, NY (US); Keith W. Flint, Glens Falls, NY (US); James F. Archambault, Fort Edward, NY (US); Leslie A. Rathbun, Victory Mills, NY (US)

Correspondence Address: NIXON & VANDERHYE P.C., 8th Floor, 1100 North Glebe Road, Arlington, VA, 22201, US

(21) Appl. No.: 10/135,830

(22) Filed: May 1, 2002

Related U.S. Application Data
(60) Provisional application No. 60/291,646, filed on May 18, 2001.

(51) Int. Cl. B67D 5/54; D21C 7/00; D21C 7/12

(52) U.S. Cl. 137/154; 137/171; 137/173; 137/197; 137/208; 162/246; 162/232; 162/237

(57) ABSTRACT

Disclosed is a pressure vessel comprising a pressurized chamber; an overflow chute having an inlet open to an upper level of the chamber, a chute passage extending from the upper level to a lower level, and a chute discharge; wherein the chute passage has a bend to defect a flow in the chute passage before the flow exits the discharge.

### RELATED APPLICATION

This application claims priority to and incorporates by reference commonly-owned U.S. Provisional Patent Application Serial No. 60/291,646, filed May 18, 2001.

### BACKGROUND AND SUMMARY OF THE INVENTION

Pressurized vessels are used in a variety of chemical processes. These vessels may receive fluids and solids under pressure. In addition, the vessel may contain gases that enter the vessel with the input fluids and solids, and gases that are generated by the fluids and solids within the vessel. These gases, especially the generation of gases, affect the pressurization of the vessel and can lead to an overpressure condition in the vessel. Further, the vessel has discharge ports for fluids and solids (generally towards the lower regions of the vessel) and a gas discharge port (generally towards the top of the vessel).

The pressurization of the vessel is problematic. The vessel is typically intended to operate at a certain internal pressure or within a predetermined range of pressures. The internal pressure of the vessel is affected by several parameters, including (at least): the input pressure of the solids/gases/fluids entering the input port of the vessel (which generally increases vessel pressure); the pressure of gases generated or consumed in the vessel (generally gases are generated that increase the vessel pressure); the draining of fluids and solids from a lower discharge port of the vessel (which tends to decrease vessel pressure), and the withdrawal of gases from the vessel (which tends to decrease vessel pressure).

The extent to which each of these parameters individually affects the vessel pressure varies with respect to magnitude of the parameter as compared to the vessel capacity. The collective effect of these parameters can be difficult to control and somewhat unpredictable. If the pressure in the vessel becomes excessive then there is a need for a pressure relief valve. If the pressure in the vessel falls below atmospheric pressure (or some other predetermined minimum pressure), then there is a need for a means providing additional pressurization to the vessel (so as to prevent collapse of the vessel). Further, if the amount of fluids and solids in the vessel exceeds the vessel capacity, then there is a need for a fluids/solids relief system from the vessel. Accordingly, there is a need for systems that provide for pressure relief, pressurization, and overflow relief in pressurized vessels.

In addition, pressure vessels often contain gases that should not be released to the atmosphere. Environmental regulations are increasingly requiring that pressure vessels have mechanisms that prevent or minimize the release of noxious and/or malodorous gases into the atmosphere. To capture these noxious gases, e.g., non-condensable gases (NCG), from a pressure vessel, the gases discharge port in the vessel is coupled to a gas discharge device pump that draws gases from the vessel. The gas pump in the withdrawal port piping is generally controlled so as to avoid depressurizing to a negative pressure the pressure vessel. However, there is a potential danger that the gas pump will operate improperly and depressurize the vessel. In a worst case scenario the gas pump on the gas discharge port can create a vacuum condition, e.g., below atmospheric pressure, in the pressure vessel. A negative pressure in the vessel can jeopardize the structure of the vessel. Accordingly, there is a need to have systems to prevent excessive negative pressures (vacuums) in a pressure vessel.

In addition, if the pressure in the vessel falls below certain minimum levels, the fluids in the vessel may boil. An overflow condition can also result if the fluid/solid input becomes excessive (especially as compared to the rate of fluid/solid withdrawal). Because of the danger of overflow, pressure vessels need a mechanism to release overflow fluids and/or solids without damaging the vessel. Typically, overflow relief ports have been towards the top of a pressure vessel and discharge overflow fluids and solids from the top of the vessel. The relief ports are towards the top of the vessel because a hallmark of an overflow condition is that the fluid/solid level in the vessel rises to the top of the vessel. The relief ports are normally designed to prevent the level of fluids and solids from exceeding a certain level in the vessel. However, discharging overflow fluids and solids from the top of a large vessel, e.g., many tens of feet tall, can result in a high-pressure outlet stream of fluids and solids jetting from the top of the vessel. This overflow stream can create a mess on the ground and be dangerous to persons and equipment on the ground near the vessel. While it is known to have an overflow chute extend from the top of a pressurized vessel to the ground, these long, vertical chutes have an extremely high-velocity flow discharge. Accordingly, there is a need for a pressure vessel overflow system that avoids discharging the overflow stream generally to the region surrounding the vessel, but rather slows and directs the overflow stream to a containment pool or overflow vessel that is normally at ground level.

Pressure vessels are commonly used in wood pulp mills as, for example, flash tanks and chip bins. The term “chemical pulping” applies to the process of treating comminuted cellulosic fibrous material, for example, hardwood or softwood chips, with an aqueous solution of chemicals which dissolve the non-cellulose components of the material, and some of the cellulose components, to produce a slurry of cellulose fibers that can be used to produce cellulose paper products. The commercially significant chemical pulping process in the late twentieth century is the alkaline process, a process more commonly referred to as the “kraft” process. In the kraft process, the active chemicals with which the wood is treated are sodium hydroxide [NaOH] and sodium sulfide [Na₂S]. The aqueous solution of sodium hydroxide and sodium sulfide is referred to as “kraft white liquor”.

Kraft pulping is typically performed at a temperature of over 100° C., and the process is typically performed under superatmospheric pressure, preferably 5-10 bar, in a sealed pressure-resistant vessel known in the art as a digester. Typically, the cellulose material is sequentially raised to this treatment temperature and pressure, and cooking chemical is introduced to the material, in a series of steps that take place in what is known in the art as the “feed system”.

In the case of a continuous digester in which material is continuously introduced at one end and discharged at the other, the feed system typically comprises or consists of several vessels for heating the material, raising its pressure, and introducing cooking liquid. For instance, continuous cooking feed systems typically include some form of chip bin (a pressure vessel) into which the comminuted cellulosic fibrous material, referred to hereafter as “wood chips” (the most common form), are first introduced. This chip bin typically includes some form of isolation device at its inlet to prevent the escape of gasses from the bin. The bin may also include an exhaust outlet for releasing the gases that may accumulate in the bin. Typically, treatment of the chips begins in the chip bin when the chips are exposed to high temperature steam. The steam begins the heating process, but, more importantly, the steam displaces the air in the chips so that the air content of chips is minimized. This removal of air and other gases from the chips promotes the “sinking” of the chips during subsequent aqueous treatment.

After steaming in the chip bin, the de-aerated chips are discharged from the chip bin by some form of metering device, for example, a Chip Meter sold by Andritz Inc., of Glens Falls, N.Y. or a metering screw or any other form of conventional metering device. After discharge from the chip bin and metering device, the pressure of the chip mass is increased from approximately atmospheric pressure to a pressure of about 18 psi. This is typically achieved by a pressure isolation device, for example, a Low Pressure Feeder [LPF] as sold by Andritz. The LPF is a device having a rotating star-type rotor within a stationary housing having an inlet and an outlet. Typically, as the rotor turns in the housing, chips drop through the inlet into the pockets of the rotor. As the rotor turns toward the outlet, the chips are exposed to a higher pressure and the chips fall through the outlet of the LPF to further treatment below. The clearance between the tines of the rotor and the inside surface of the housing are closely toleranced so that the higher pressure typically below the LPF does not escape to the area of lower, atmospheric pressure above and around the LPF.

The LPF typically includes some form of steam purge to purge the rotor cavities of chips during and after the chips are discharged from the outlet of the feeder. This purge usually comprises or consists of low-pressure steam introduced to a port in the housing of the feeder. The LPF also typically includes some form of exhaust gas relief port to release any gases that may accumulate in the feeder such that these typically pressurized gases are not introduced to the inlet of the feeder where they can interfere with the flow of chips into the feeder or interfere with the flow of chips through the metering device or chip bin above.

In conventional feed systems, the LPF discharges chips to the pressurized atmosphere of another treatment vessel. Conventionally, this vessel typically performs a further treatment of the chips with steam under a pressure of about 18 psi. This conventional pressurized steaming typically removes any further air that may be present and also increases the temperature of the chips to about 120° C. prior to being immersed in cooking liquor. One preferred treatment vessel for performing this pressurized steam treatment is a Steaming Vessel as sold by Andritz. The Steaming Vessel is most often a horizontally-oriented vessel having a cylindrical housing and horizontal screw conveyor. Steam is added to the housing through one or more ports typically located on the bottom of the housing. The source of this steam is typically flashed spent cooking liquor. That is, hot cooking liquor removed from the cooking process in the digester is expanded under controlled conditions by exposing the liquor to a pressure lower than its boiling point. In addition to generating steam from the flashed liquor, other volatile, typically malodorous, gases are also generated in the flashing process, such as hydrogen sulfide [H₂S], methyl mercaptan [CH₃SH], dimethyl sulfide [CH₃SCH₃], and dimethyl disulfide [CH₃SSCH₃], as well as other often malodorous gases. These gases, which are referred to collectively as Total Reduced Sulfur gases or TRS gases, are typically also introduced to the chips in the pressurized steaming process, typically in a Steaming Vessel. These chip bins, flush tanks and steaming vessels are pressure vessels. The present invention solves problems in pressure vessels associated with avoidance of vacuums in the vessel and handling of overflow conditions.

An embodiment of this invention is a pressure vessel comprising: a pressurized chamber; an overflow chute having an inlet open to an upper level of the chamber, a chute passage extending from the upper level to a lower level, and a chute discharge; wherein the chute passage has a bend to deflect a flow in the chute passage before the flow exits the discharge.

Another embodiment of the invention is a pressure vessel comprising: an pressurized chamber having a vertical centerline; a vertical peak to the chamber offset from the vertical centerline, wherein said peak includes a gaseous discharge port, and an inlet to an upper portion of the chamber coaxial with the vertical centerline, wherein the inlet is vertically lower than the gaseous discharge port.

A further embodiment of the invention is a pressure vessel comprising: a pressurized chamber; an overflow chute having an inlet open to an upper level of the chamber, a chute passage extending from the upper level to a lower level, and a chute discharge; wherein the chute discharge has a door hinged to an upper edge of an inclined discharge frame, wherein a weight of the door holds the door shut against the frame and a flow from the flow chute forces the door open.

The present invention provides an effective system and method for handling exhaust gases and overflow fluids and solids from a pressure vessel. This and other objects of the invention will become clear from an inspection of the detailed description of the invention and from the appended claims.

### BRIEF DESCRIPTION OF THE DRAWINGS

FIG. 1 is a schematic view of an exemplary pressure vessel for a pulp mill.

FIG. 2 is a schematic cross-sectional view of a vacuum protected door for the pressure vessel shown in FIG. 1.

FIG. 3 is a schematic enlarged side view of an overflow chute for the vessel shown in FIG. 1.

FIG. 4 is schematic plan view of an overflow chute shown in FIG. 2.

### DETAILED DESCRIPTION OF THE DRAWINGS

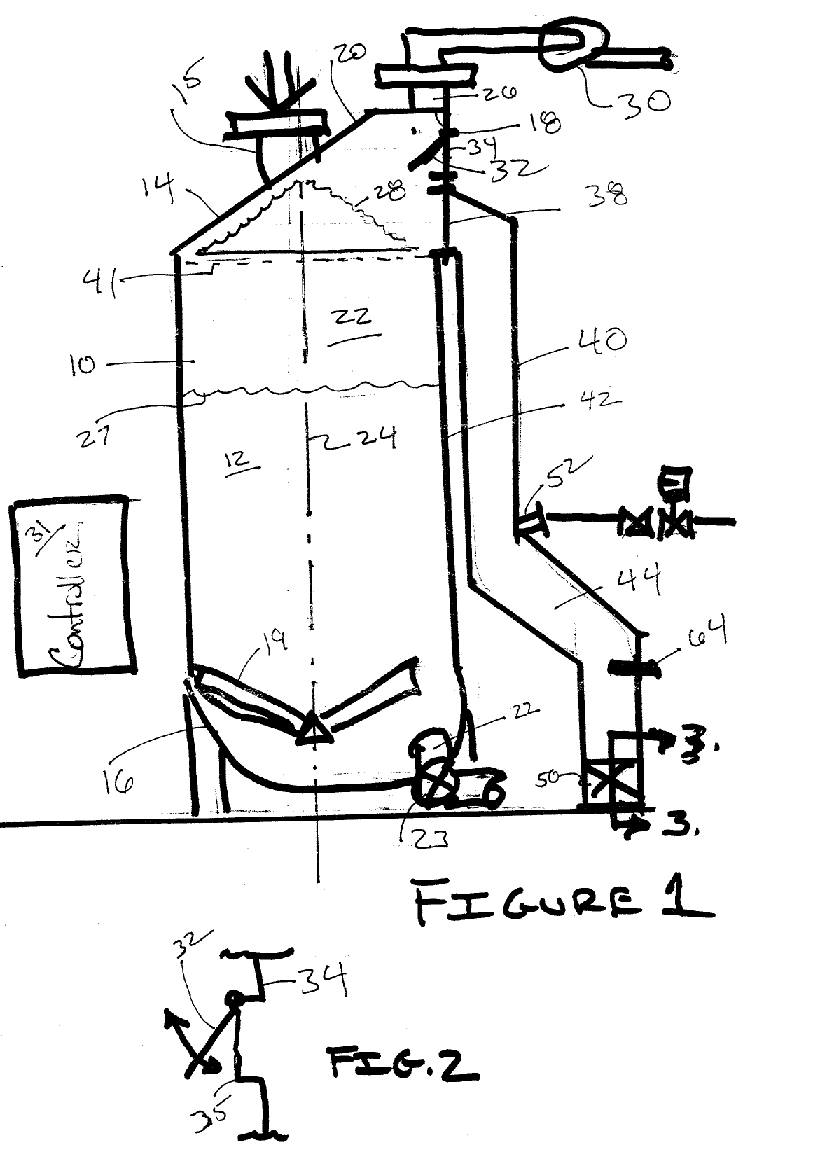

FIG. 1 illustrates a pressure vessel system 10 that may be used in a pulp mill for a comminuted cellulosic fibrous material retention vessel, chip bin, or other purposes. The pressure vessel may include a generally cylindrical tank 12, an off-centered upper chamber 14, and a lower discharge chamber 16. The upper chamber may have a generally eccentric conical shape having a peak 18 and sidewalls 20 that extend from the peak to the upper edge of the tank 12. The upper chamber and lower discharge chamber are attached to or integral with the tank. The upper chamber 14, lower discharge chamber and tank together form a continuous internal pressure chamber 22 within the pressure vessel 10.

The bottom of the pressure chamber 22 is formed by the lower discharge chamber 16, that may be a semi-hemispherical shell that is attached to or integral with the lower edge of the tank 12. There may be a conventional rotary solids/fluid feed mechanism 19 in the lower chamber 16 that assists in moving fluids and solids, e.g. wood pulp, to a lower fluids and solids discharge port 22. This discharge port is generally at the bottom of the lower chamber 16 is allows pulp, fluids and solids (but not gases) to exit the pressure vessel at a controlled rate. The discharge port may include a valve 23.

The upper chamber 14 may have an off-centered pyramid shape with triangular, flat walls 20. Alternatively, the upper chamber may have a curved surface shaped as an off-centered cone. A characteristic of the upper chamber is that its peak 18 is offset from the vertical centerline 24 of the pressure chamber 22. The peak is the highest point in the pressure chamber and is a desirable location for the gaseous outlet port 26. Gases in the pressure chamber generally rise. Thus, the peak of the chamber is a preferable outlet location to remove the gases. In addition, the peak is above the level 27 of the fluids and solids in the vessel. Thus, an outlet port at the peak is unlikely to draw fluids and solids.

As the material enters the vessel, a mound or cone shaped area, 28, with an angle of repose of approximately 40° to 45° is formed when the vessel operates full. This mound is below the intake port 15 and is necessary for proper material flow and aids in the prevention of vessel over-pressurization. The apex of the mound is ideally aligned with the centerline of the pressure vessel. Fluids and solids entering the vessel through the intake port pour onto the apex of the mound, flow down and are distributed across a cross-section of the vessel.

The outlet port 26 is coupled to a gaseous discharge pipe that may be connected to a discharge pump, eductor, or compressor 30. The pump or compressor creates a slight pressure drop in the discharge pipe such that gases are drawn out of the vessel. The evaluation device is controlled so that the pressure drop in the discharge pipe is slight and does not cause a substantial pressure drop in the pressure vessel. A pressure vessel controller 31 may include a computer processor that acts on sensor input signals to operate the gas discharge pump or compressor, the discharge valve 23 and to control the flow through the inlet port 15. However, the controller may fail for the pump or compressor and result in a substantial pressure drop in the discharge pipe. There is a danger that the discharge pipe will create a vacuum in the pressure vessel.

As shown in FIG. 2, the upper chamber 14 has a vacuum relief door 32 in the chamber wall and adjacent to the peak 18. It is preferable that the chamber wall having the door be vertical (or inclined inwardly) so that the door swings closed under the force of gravity. The vacuum door 32 is hinged to a vertical wall 34 of the upper chamber 14 such that the door swings inward into the pressure vessel. The door is forced closed and sealed against a door frame 35 in the vertical side-wall 34 of the chamber wall by positive pressure in the vessel, e.g., pressure above atmospheric pressure. As long as the internal pressure in the vessel exceeds atmospheric pressure (or the pressure outside of the vessel), then the vacuum door is closed and the vessel is sealed. However, the vacuum door will open, if the pressure in the vessel falls below the pressure outside the vessel (which is normally atmospheric pressure). When the vacuum door opens, air (or other gases) from outside the vessel is drawn into the vessel and thereby avoids having a vacuum form in the vessel. Moreover, the door is open only when the pressure in the vessel is below the external pressure and, thus, the flow of gases (air) is from outside the vessel to in the vessel (and not vice versa). The door closes when the pressure in the vessel is equal to or greater than the external pressure. Accordingly, the vacuum door does not allow hazardous and/or noxious gases from inside the vessel to escape out of the vessel and into the atmosphere.

The input port 15 for the pressure chamber is preferably aligned with the centerline 24 of the pressure chamber. The inlet pipe 36 is vertical and coaxial with the vertical centerline 26 of the pressure vessel. The inlet port is not at the peak of the vessel and need not be at the peak. By shifting the peak to be offset from the centerline, the pressure vessel has advantageously a gaseous outlet port at the peak and an inlet port aligned with the vertical centerline of the vessel.

The vertical wall 34 also has an overflow port 38 that connects to an overflow chute 40. The overflow port is horizontally aligned with a level 41 in the vessel that corresponds to a fluid or solids overflow condition. If and when the level 27 of the fluid or solids in the vessel rise to the level 41 of the overflow port, then fluid and solids are drained from the pressure vessel, through the port and into the overflow chute 40. The overflow chute is generally vertical and adjacent the outside wall of the tank of the vessel. The chute is a conduit for overflow fluid and solids and directs those fluid and solids to ground level.

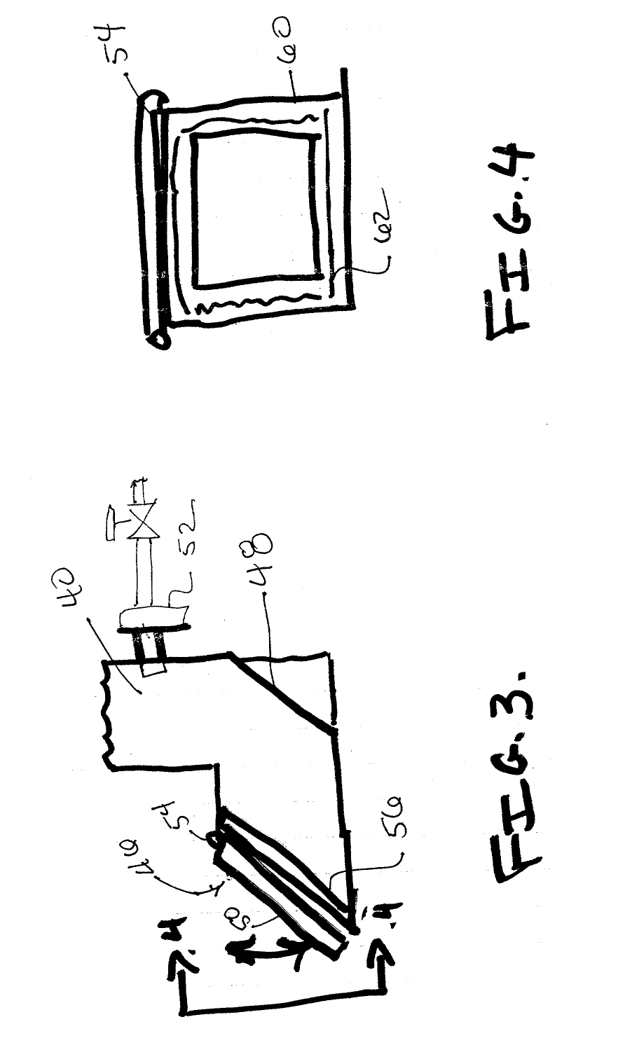

The chute 40 may be tens of meters high, and extend substantially the entire height of a vertical pressure vessel. The chute may be circular, elliptical, rectangular or some other shape in cross section. As the fluid and solids fall through the chute, they can gain tremendous velocity and kinetic energy. To dissipate the energy of the overflow fluid and solids, the chute has an “S” shaped turn 44 that turns and slows the overflow fluid and solids. When the fluids and solids discharge from the chute outlet 46, they are flowing slower than they would otherwise had the chute lacked the S-turn. Moreover, there is an energy adsorbing inclined wall 48 (FIG. 3) near the chute outlet that forms a slanted corner to direct the vertical chute flow to a generally horizontal flow and towards the outlet. In addition to further slowing the flow of the overflow fluids and solids, the inclined wall turns the flow towards the chute outlet and minimizes the formation of eddy currents in the flow at a corner in the chute were fluids and solids can collect. Further, the lower end of the chute (near the outlet door 50) includes at least one clear water inlet jet 52. The water jet is used to clear the bottom of the chute and clean debris from the chute.

The door 50 of the outlet to the chute is hinged 54 at an upper edge of the chute outlet so that the door opens outward under pressure of the flow in the chute. The door is weighted and door frame 56 is inclined such that door shuts under the force of gravity. To open the door, a force must be applied such as the force of the flow of overflow fluids and solids. A neoprene (or other soft gasket material) gasket 60 is on the door frame at the discharge outlet of the chute. The gasket provides a seal between the door and chute to prevent air from entering the chute and filling the chute and upper section of the pressure vessel. In addition, the gasket seal prevents noxious gases from leaking out of the chute (however these gases tend to be hot and do not drift downward through the chute). Further the door has an electric or steam trace 62 around the periphery of the door to ensure proper operation in all external weather conditions.

The overflow chute 40 includes sensors 64 to detect when an overflow occurs in the chute. For example, a temperature sensor senses a significant temperature change in the chute which may be used to detect the overflow of a hot (or cold) fluid from the pressure vessel. The temperature sensor sends signals to a controller 31 that operates the vessel, such as operating the valves and pumps that control the inlet and discharge flows in the vessel. While a temperature sensor is shown, the sensor may be a pressure sensor, flow sensor or some other means for detecting the presence of fluid flow through the outlet chute passage. For example, if an overflow is detected in the chute (such as from temperature signals from the temperature sensor), then the controller 31 may automatically purge the vessel by fully opening the discharge valve 23 in the fluid/solid discharge chute, and accelerate the pump/compressor 30 to relieve pressure, e.g., steam pressure, from the vessel.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims, and limited only by the prior art.

What is claimed is:

1. An overflow chute for a vessel comprising:
a chute inlet open to an upper level of a vessel containing a fluid susceptible to overflowing the vessel;
a chute passage extending from the upper level to a lower level of the vessel, and
a chute discharge, wherein the chute passage has a bend to deflect a flow in the chute passage before the flow exits the discharge.

2. An overflow chute as in claim 1 wherein the chute is adjacent the vessel.

3. An overflow chute as in claim 1 wherein the vessel and chute are each over ten meters in height.

4. An overflow chute as in claim 1 wherein the chute passage is vertical and the bend is a S-shaped turn in the passage.

5. An overflow chute as in claim 1 wherein the bend is an inclined wall of the chute passage adjacent the chute discharge.

6. An overflow chute as in claim 1 wherein the vessel is a flash tank and has a center inlet port for receiving hot fluids.

7. An overflow chute as in claim 1 wherein the vessel is chip bin and has a center inlet port for receiving a slurry of wood chips.

8. An overflow chute as in claim 1 wherein the vessel is a pressure vessel.

9. An overflow chute as in claim 1 wherein the chute discharge is at a ground level.

10. A vessel comprising:
a chamber;
an overflow chute having an inlet open to an upper level of the chamber, a chute passage extending from the upper level to a lower level, and a chute discharge;
wherein the chute passage has a bend to deflect a flow in the chute passage before the flow exits the discharge.

11. A vessel as in claim 10 wherein the chute passage is vertical and the bend is a S-shaped turn in the passage.

12. A vessel as in claim 10 wherein the bend is an inclined wall of the chute passage adjacent the chute discharge.

13. A vessel as in claim 10 wherein the vessel is a flash tank and has a center inlet port for receiving hot fluids.

14. A vessel as in claim 10 wherein the vessel is chip bin and has a center inlet port for receiving a slurry of wood chips.

15. A vessel as in claim 10 wherein the vessel is a pressure vessel.

16. A vessel as in claim 10 wherein the chute discharge is at ground level.

17. A fluid vessel comprising:
an pressurized chamber having a vertical centerline;
a vertical peak to the chamber offset from the vertical centerline, wherein said peak includes a gaseous discharge port, and
an inlet to an upper portion of the chamber coaxial with the vertical centerline, wherein the inlet is vertically lower than the gaseous discharge port.

18. A fluid vessel as in claim 17 further wherein the internal pressurized chamber includes a cylindrical tank and an eccentric upper housing having the peak and inlet, and said upper housing has a triangular cross-section extending from the peak and downward to an upper edge of the cylindrical tank.

19. A fluid vessel as in claim 17 wherein the triangular cross-section of the upper portion is a right triangular cross section.

20. A fluid vessel as in claim 17 wherein the vessel is vertical.

21. A fluid vessel as in claim 17 wherein the pressure vessel is a flash tank and has a center inlet port for receiving hot fluids.

22. A fluid vessel as in claim 17 wherein the pressure vessel is chip bin and has a center inlet port for receiving a slurry of wood chips.

23. A fluid vessel as in claim 17 wherein the pressurized chamber further comprises a vacuum door that allows outside gas to enter the chamber if a pressure in the chamber falls below an outside vessel pressure.

24. A fluid vessel as in claim 17 wherein the pressurized chamber is pressurized to a pressure above atmospheric pressure.

25. A pressure vessel comprising:
a pressurized chamber;
an overflow chute having an inlet open to an upper level of the chamber, a chute passage extending from the upper level to a lower level, and a chute discharge;
wherein the chute discharge has a door hinged to an upper edge of an inclined discharge frame, wherein a weight of the door holds the door shut against the frame and a flow from the flow chute forces the door open.

26. A pressure vessel as in claim 25 wherein the discharge frame includes a gasket that abuts the door.

27. A pressure vessel as in claim 26 wherein the gasket is deformable.

28. A pressure vessel as in claim 26 wherein the gasket is neoprene.

29. A pressure vessel as in claim 26 wherein the gasket is heated.

30. A pressure vessel as in claim 25 further comprising a liquid jet in the overflow chute.

31. A pressure vessel as in claim 25 further comprising a sensor in the chute, and a controller operatively connected to an fluids discharge outlet valve of the chamber, and wherein said controller opening the valve in response to a sensor signal indicating a fluid flow in the overflow passage.
